(19) United States
(12) Patent Application Publication
(10) Pub. No.: US 2007/0002753 A1
(43) Pub. Date: Jan. 4, 2007

(54) System and method for testing a packet data communications device

(76) Inventor: Michael D. Bailey, Fort Worth, TX (US)

Correspondence Address: MICHAELSON & ASSOCIATES, P.O. BOX 8489, RED BANK, NJ, 07701, US

(21) Appl. No.: 11/171,487

(22) Filed: Jun. 30, 2005

(51) Int. Cl. H04L 12/26; H04L 12/66

(52) U.S. Cl. 370/241; 370/352

(57) ABSTRACT

Apparatus and accompanying methods for use therein for implementing a method and system for emulating a supporting mobile for testing a packet-data communication device. Thus, the present invention is directed to, in a general aspect, a system, and accompanying methods for use therein, for packet data communications. In a preferred embodiment the invention relates to testing of packet data applications including wireless communications such as push to talk over cellular (PoC) wireless telecommunications applications. The test system of the present invention comprises an emulated communication device for transmitting and receiving packet data and a controller for controlling the emulated communications device. The controller operatively connected to the emulated communication device and the controller enables the emulated communications device to emulate the communications device by performing functions that the communication device performs.

### BACKGROUND OF THE DISCLOSURE

1. Field of the Invention

The invention relates to a system, and accompanying methods for use therein, for packet data communications and in particular testing of packet data applications including wireless communications such as push to talk over cellular (PoC) wireless telecommunications applications.

2. Description of the Prior Art

Mobile telecommunication is typically provided through the use of systems such as cellular or PCS (Personal Communication Services). These systems can employ various mobile or wireless technologies. Wireless technologies, for example, CDMA, WCDMA, GSM, 1xEV, GPRS, CDMA2000, WLAN, location services, broadband data and VOIP (Voice over Internet Protocol), are being developed or evolving at a fast rate.

Circuit switching has been used in wireless networks for a long time. Circuit switching (non-packet data service) is continuous in that it is a network resource reserved for the user for the full duration of a conversation. Packet switching is quickly taking over the place of circuit switching as the preferred solution for processing voice data. Packet switching was developed for data communications and can be used for other communications such as voice and video; that is communications where the data can be packetized into bits. Packets can be created and forwarded through packet switches (i.e., routers) to terminate at their destination(s). Each packet receives a sequence number and multiple packets that comprise a message are reassembled at the termination point.

One packet data technology experiencing growth in use is VoIP. VoIP works by use of a data network to transmit a voice call in the form of data packets. The term “Internet Protocol” implies encoding a voice call and transmitting it between terminals on a data network. The benefits to use of VOIP are great and include: decreased expense, easier management, and additional service (i.e., messaging, number portability, and account management over the Internet). Some reasons for implementing VoIP include toll-bypass, network consolidation, and service convergence.

Mobile handsets called Push-to-Talk over Cellular (referred to herein as PTT or PoC) use VoIP technology and can be deployed over most networks including existing infrastructure traditionally used for circuit switched communications. These PoC mobile handsets provide functionality similar to a two-way radio. PoC mobile subscribers can use PoC handsets anytime packet data service is available and without the geographic limitations of two-way radios.

As the next generation of mobile handsets and wireless devices emerge, the demand on packet data services is growing. Future revenue growth of service providers is highly dependent on packet data services as voice revenue declines. As wireless technologies are deployed and expanded across the globe, consumer expectations for reliability and quality of service (QoS) rise. In order to satisfy customer expectations, a focus must be made toward reliability and QoS. Proper testing plays an important, significant role in meeting these expectations.

Mobile service providers and network equipment manufacturers require the proper test tools to ensure data services meet customer expectations, including QoS expectations. Testing and managing wireless technologies and applications throughout the development, verification, deployment and management of next-generation wireless devices and networks allows for improved reliability and QoS. During the product development cycle, test solutions, such as those available from Spirent Communications of Rockville, Md., the assignee of the present invention, qualify performance and identify breakpoints, allowing issues to be resolved prior to deployment.

Previously available test solutions have enabled the testing of mobile handsets, also known as mobiles under test (MUTs), using loopback circuit switched testing where a signal is transmitted from a MUT and returned to that MUT using loopback. The MUT communicates with a network emulator. The network emulator sends voice back to MUT; a supporting mobile (SM) does not receive the voice signal. Loopback testing cannot be used with PoC equipment because of the requirements of the PoC equipment (i.e., active push) and the signal structure being “packetized.” That is, loopback testing cannot be used with PoC because packet data applications (such as PoC) require an interactive scenario with the SM handset it is communicating with. Therefore, packet data applications cannot be tested using an echo (loopback) of what it transmits.

It has been a common problem in the prior art that performance and protocol testing on a PTT MUT could only be done on a live RF network using real supporting mobiles (SMs). A disadvantage of testing on a live RF network is the inability to eliminate or control network and RF related variables. Because of this, it is difficult or impossible to obtain repeatable and reliable results within and between different mobiles. Another disadvantage of testing on a live RF network is that the network is often not available or only available late in the design and verification process. Yet another disadvantage of testing on a live RF network is the limited capability to perform adversarial-based protocol test cases. Protocol testing on a live RF network can only support “success” test scenarios, whereas testing using emulated supporting mobiles (SMs) allows for testing of both “success” and “fail” test scenarios.

Thus, a need exists in the art for a flexible test solution designed to evaluate issues that can adversely impact PoC service end user experience include timing delays, speech quality and robustness of service. Attempting to quantify PoC performance in these areas using field-testing is time consuming, unreliable and incomplete. This results from the complex integration of network components, uncontrolled field test environments and evolving PoC requirements, make it difficult or impossible to duplicate many desired test scenarios on a commercial (live) network.

Thus, a flexible test solution is needed that objectively quantifies PoC handset performance and ultimately the end-user experience, providing a controllable environment with repeatable, configurable test cases, ultimately reducing test time from days or weeks to hours.

Further, a need exists in the art for an automated lab-based performance and protocol analysis system designed for the many phases of VoIP PoC handset testing from research and development to test and deployment and pre-acceptance testing to quantifying the performance prior to deployment.

### SUMMARY OF THE INVENTION

This invention overcomes the disadvantages of the prior art by providing a method and system for emulating a supporting mobile for testing a packet-data communication device. Thus, the present invention is directed to, in a general aspect, a system, and accompanying method for use therein, for packet data communications. In a preferred embodiment the invention relates to testing of packet data applications including wireless communications such as push to talk over cellular (PoC) wireless telecommunications applications.

The foregoing is accomplished by providing a device that can test a communication device. The communication device being tested (an MUT) is configured for transmitting and receiving packet data. The test system of the present invention resides on a system controller computer. The test system of the present invention comprises an emulated communication device for transmitting and receiving packet data and a controller for controlling the emulated communications device. The controller operatively connected to the emulated communication device and the controller enables the emulated communications device to emulate the communications device by performing functions that the communication device performs.

Further, the foregoing is accomplished by providing a method for testing a communication device. The communication device configured for transmitting and receiving packet data. The method comprising the steps of a) providing an emulated communications device configured for transmitting and receiving packet data; b) obtaining a first data by the communications device; c) sending a first data in packet data format from the communication device to the emulated communications device; d) receiving by the emulated communication device the first data sent in packet data format by the communications device; e) recording by the emulated communications device, the first data sent in packet data format by the communications device; f) obtaining the first data by the emulated communications device; and g) comparing the first data obtained by the emulated communications device with the recorded data recorded by the emulated communications device.

Thus, an advantage of the present invention is that it provides reduces or substantially eliminates a number of network and device variables as compared to using a real mobile (including for example RF, Device and PTT Client). Another advantage is that the present invention allows performance and protocol testing of PTT devices much earlier in the design and verification process. Yet another advantage of the present invention is that it allows for much more extensive adversarial-based test cases. Yet another advantage of the present invention is that it allows for much more extendible and scaleable test solution as additional software based emulated supporting mobiles can be easily instantiated in software. Yet another advantage of the present invention is that it supports either a real or emulated PTT Control Server. Other advantages of the invention will in part be obvious and will in part be apparent from the specification. The aforementioned advantages are illustrative of the advantages of the various embodiments of the present invention.

### BRIEF DESCRIPTION OF THE DRAWINGS

The teachings of the present invention can be readily understood by considering the following detailed description in conjunction with the accompanying drawings, in which:

FIG. 1a shows a block diagram illustrating a computer system with which an embodiment of the present invention may be implemented or controlled;

FIG. 1b shows a block diagram illustrating the connection of the computer system as part of an embodiment of the present invention and illustrates the hardware architecture of a test system on which the emulated PoC mobile handset is performed;

FIG. 1c shows another block diagram illustrating the system configuration including the connection of the computer system to an embodiment of the present invention;

FIG. 2a shows a block diagram of a prior art loopback testing configurations illustrating a base station between two mobile handsets;

FIG. 2b shows a block diagram of a prior art loopback testing configuration showing a communication tower and a network entity between two mobile handsets;

FIG. 3a shows a block diagram of the testing configuration illustrating a base station between a push-to-talk mobile handset and an emulated push-to-talk mobile handset;

FIG. 3b shows block diagram of the testing configuration used with the apparatus of the present invention illustrating an emulated push-to-talk mobile handset;

FIG. 4a shows a block diagram illustrating a configuration of a test system integrating an embodiment of the present invention;

FIG. 4b shows another block diagram illustrating a configuration of a test system integrating an embodiment of the present invention;

FIG. 5 shows a block diagram of an embodiment of the present invention illustrating software architecture, as well as hardware and components;

FIG. 6 shows an upper level flow chart illustrating steps performed by the embodiment the system of FIG. 5.

To facilitate understanding, identical reference numerals have been used, where possible, to designate identical elements that are common to the figures.

### DETAILED DESCRIPTION

After considering the following description, those skilled in the art will clearly realize that the teachings of my invention can be readily utilized in real-time packet data testing including real-time QoS testing.

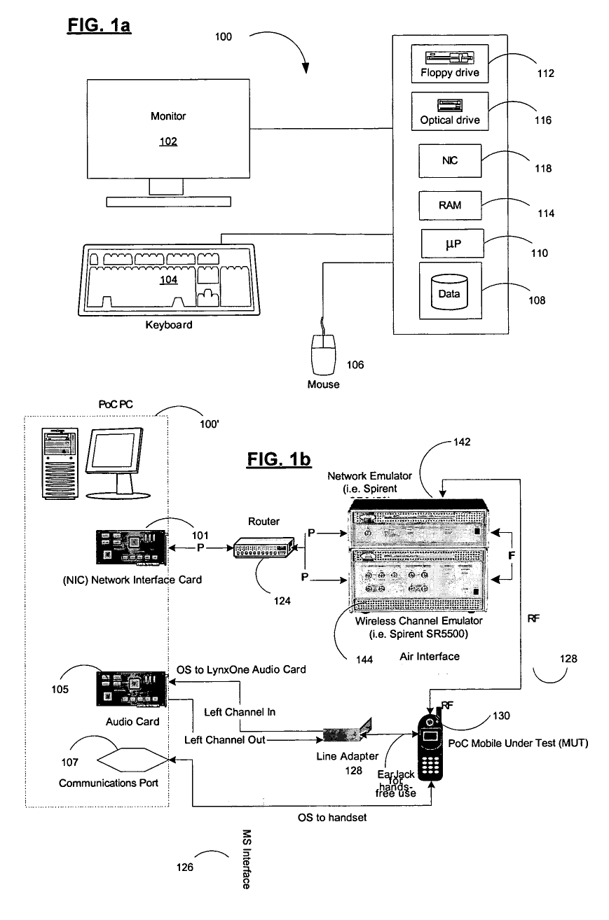

FIG. 1a is a block diagram that illustrates a computer system 100 with which an embodiment of the invention may be implemented. Computer system 100 may be a personal computer which is used generically and refers to present and future microprocessing systems with at least one processor operatively coupled to a user interface, such as a display 102 and keyboard 104, and/or a cursor control, such as a mouse or a trackball 106. The personal computer 100 may be a workstation that is accessible by more than one user. The personal computer 100 also includes a conventional processor 110, such as a Pentium™ microprocessor manufactured by Intel, and conventional memory such as hard drive 108 and memory 114, as well as removable memory ports, i.e., floppy drive 112, optical drive 116, for use in interfacing with removable memory devices (not shown) such as diskettes, flash memory and/or compact discs. The personal computer 100 is also configured with a NIC (Network Interface Card).

The computer system 100 can be configured in order to perform the functions of an emulated mobile handset (also referred to herein as an emulated PoC Mobile Handset or emulated PTT Mobile Handset) of the present invention, as is shown in FIG. 1b. An emulated supporting mobile (SM) 140 (shown in FIG. 1c) is a software entity that runs on the computer system 100′.

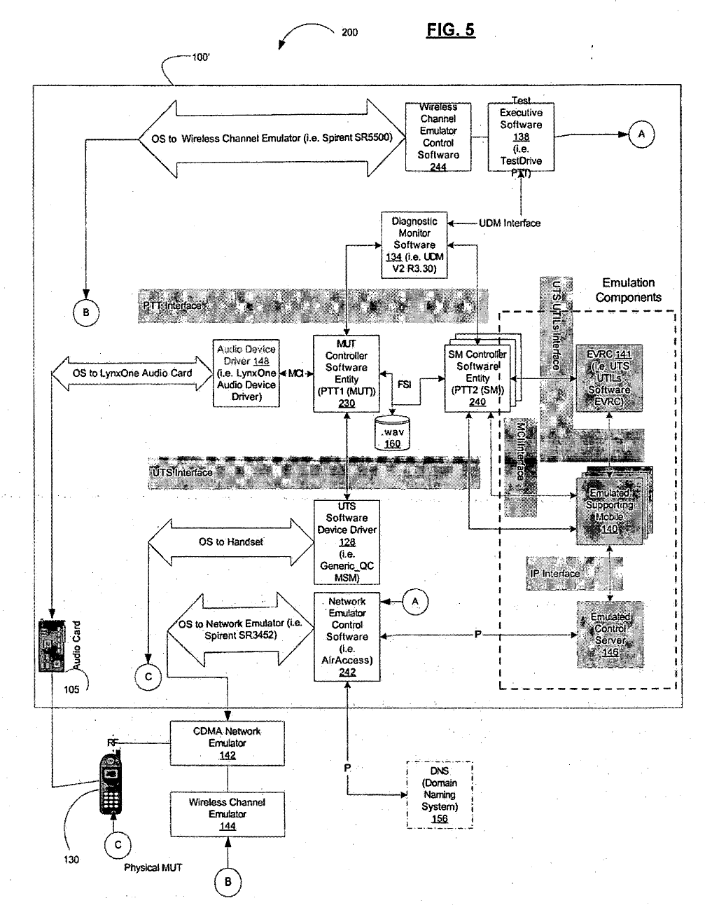

FIG. 1b illustrates the hardware architecture of a test system on which the emulated PoC mobile handset (shown in FIG. 5) is performed. The hardware architecture includes a PoC computer 100′ (also known as software platform PC) which is configured to include a NIC (Network Interface Card) 101, audio card 105 and communications port 107). The software platform PC 100′ can be, for example a Spirent APEX C2K: PoC PC, commercially available from Spirent Communications of Rockville, Md., the assignee of the present invention.

Operatively connected to the PoC computer 100′, through router 124, are a network emulator control software 142 and wireless channel emulator 144. The network emulator control software 142 outputs an IF (Interfacing Function) signal containing network traffic to the wireless channel emulator 144. IF is a radio frequency (RF) signal that has not been amplified. The wireless channel emulator 144 adds noise and fading to the IF signal and outputs the signal back to the network emulator control software 142. The network emulator control software 142 then amplifies the signal to output to the MUT 130. The network emulator can be, for example, a Spirent SR3452 Network Emulator; and the wireless channel emulator can be, for example, a Spirent SR5500 Wireless Channel Emulator (both manufactured by Spirent Communications of Rockville, Md., the assignee of the present invention). The network emulator emulates a real-time network and base station. The wireless channel emulator 144 emulates fading conditions, simulating signal fade that would similarly be found in a real-time environment. A PoC mobile under test (MUT) handset 130 is connected to PoC computer 100′ and network emulator 142 via MS interface (software device driver) 126 and air interface 128, respectively.

FIG. 1c shows another block diagram 200 of a Push to Talk Over Cellular test system 200 configuration including an emulated supporting mobile. A system controller PC 100′ includes various software components: voice quality analysis software 132 (such as Opera™ voice quality analysis software), test case data 138 (such as Spirent TestDrive suite of test cases), diagnostic monitor 134 (such as UDM Universal Diagnostic Monitor used to analyze and monitor performance of mobile devices and networks) and emulated supporting mobile (PoC Client) software 140. The test system also comprises wireless channel emulator 144 and CDMA network emulator 142, as well as emulated control server 146 (such as Spirent 3910 PoC Server Emulator. The emulated control server 146 emulates PoC services.

The system controller PC 100′ provides automated test case control, execution and report generation. The test case data 128 includes test cases to ensure interoperability with the PoC control server 146 and network resources, as well as adversarial tests. Emulated supporting mobile 140 acts as a controlled reference device. The preferred, commercially available OPTICOM OPERA software 132 is a voice quality measurement software application. Diagnostic monitor or Spirent UDM software automates testing through mobile handset control and monitoring. A user may chose to use test case software designed specifically for a particular manufacturer's mobile device. For example, commercially available Verizon Wireless PoC Test Suite includes test cases from the Verizon PoC Performance Test Plan. The system controller PC 100′ preferably uses Spirent TestDrive PoC Software.

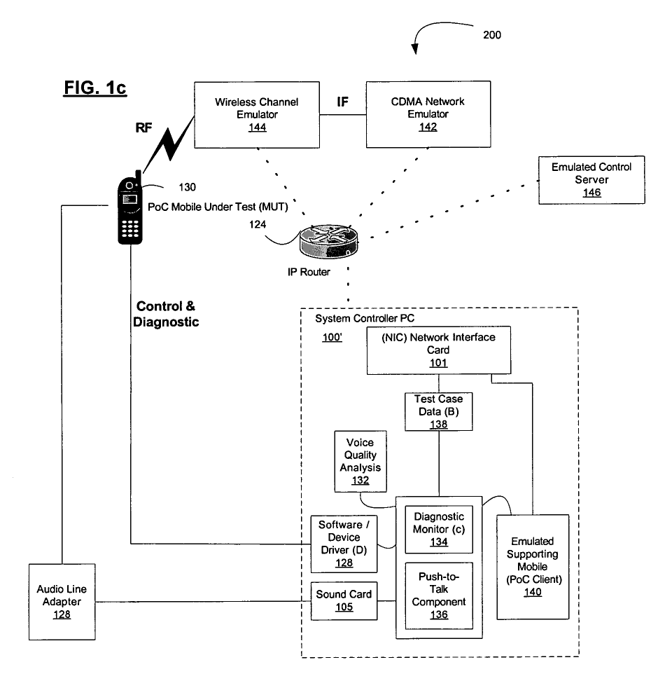

FIG. 2a shows a block diagram of a prior art loopback testing configurations illustrating a base station between two mobile handsets. The prior art mobile handsets 90 can be analog or digital cellular or PCS mobile handsets. The signals transmitted by the mobile handsets are continuous, non-packet, circuit switched. The prior art mobile handsets 90 do not use push-to-talk therefore, the signal being transmitted via mobile handset 90a through base station 150 to mobile handset 90b does not need to be rebuilt as would a packetized signal. Hence, prior art testing of mobile handsets can be done by using a loopback technique. Curved line L represents a loopback test signal.

In FIG. 2a, as well as FIG. 2b, signal L is transmitted from mobile device 90a (also known as the sending device) and is looped back to the sending device which is waiting for its return. Measuring the differences between the sent and received signal is fundamental to loopback testing. The Base Station 150 represents, for example, a tower that is transmitting signal to and from mobile handsets 90a and 90b. The base station could also represent a fixed station used for communicating with mobile handsets (a base station generally is a transmitter/receiver location between the wireless system and the wireless device). Each cell in a cellular network requires a base station.

FIG. 2b shows another block diagram of a prior art loopback testing configuration further illustrating communications towers 152, 152′ and network entity 154. The dotted line around communications tower 152 and network entity 154 indicates that these components can be emulated by a network emulator such as, for example, Spirent Air Access CDMA Network Emulator, commercially available from Spirent Communications of Rockville, Md., and the assignee of the present invention. Generally, a network entity is a generic term for any component (hardware or software) in a network.

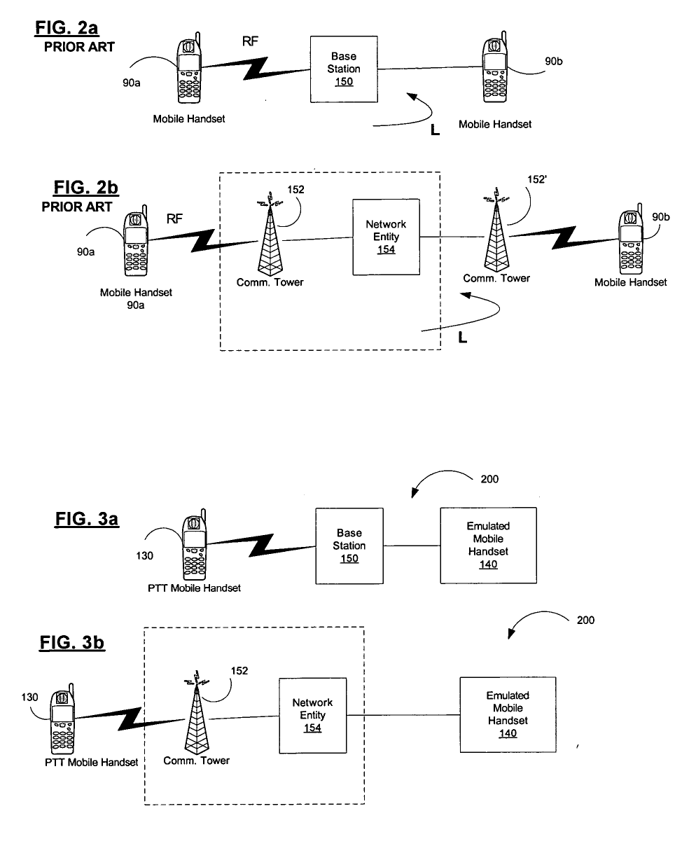

FIG. 3a shows a block diagram of the testing configuration 200 illustrating a base station 150 between a PTT mobile under test (MUT) handset 130 (also referred to herein as physical MUT 130) and an emulated push-to-talk mobile handset 140 (also referred to herein as an emulated SM (supporting mobile)). The PoC mobile under test (MUT) handset corresponds to the PoC mobile under test handset of the hardware configuration of FIG. 1b. The emulated supporting mobile handset 140 corresponds to the emulated Supporting Mobile (PoC client) of the system configuration of FIG. 1c. Notice that there is no loopback testing in FIG. 3a because the operation of the PTT mobile handset 130 cannot support loopback testing. In order for the PTT mobile handset to gain transmission rights, a “push” key must be depressed. Testing of the PTT handset cannot take place using the loopback test configuration of the prior art. Hence, there is a need for the emulated supporting mobile 140 of the present invention.

FIG. 3b shows another block diagram of a testing configuration implementing the present invention and illustrating an emulated mobile handset 140. FIG. 3b further illustrates a communication tower 152 and network entity 154. The dotted line around communications tower 152 and network entity 154 indicates that these components can be emulated by a network emulator such as, for example, Spirent Air Access CDMA Network Emulator, commercially available from Spirent Communications of Rockville, Md., the assignee of the present invention.

In the testing configuration of FIGS. 3a and 3b, real mobiles could be used instead of the emulated supporting mobile of the present invention. However, the emulated supporting mobiles of the present invention are more cost effective than real mobiles since real mobiles can be scarce and expensive. The reason that real mobiles are scarce and expensive during development is that when a mobile device is in the development stage, very few are built and the price is very expensive (i.e., tens of thousands of dollars each versus a hundred dollar post development retail price). Therefore, it is difficult to obtain access to a mobile under development. Post development mobile devices, i.e., retail mobile devices, are available and inexpensive by comparison. The present invention allows for performance and protocol testing of PoC devices to support testing during development, and after, through the use of an emulated mobile device such as supporting mobile 140. Another reason to not use real supporting mobiles at this stage is that during its development the mobile may not work reliably or correctly and therefore it may introduce uncertainty—when error(s) occur—as to whether the error(s) were caused by the MUT or the real SM.

The system of FIG. 5 is an example of a specific application of the emulated device 140 of the present invention implemented in a mobile telecommunications network environment. The emulated packet data test device 140 could be used for other packet data device testing where real-time QoS needs to be determined in a cost efficient manner.

FIG. 5 shows a block diagram of an embodiment of the test system 200 incorporating the emulated mobile 140 of the present invention illustrating software architecture and interface of various software components with various system software and hardware. The software architecture is configured so that test executive 138 provides control, commands and analysis for the system 200. The test executive 138 can be, for example, a Spirent TestDrive PoC, manufactured by Spirent Communications of Rockville, Md., the assignee of the present invention. The test executive 138 is preferably a windows based test executive that automates test system 200 control, configures the system 200 and executes tests including results collection and report generation.

The test executive 138 interfaces with diagnostic monitor software 134 such as, for example, commercially available UDM V2, manufactured by Spirent Communications of Rockville, Md., the assignee of the present invention. The interface between the test executive 138 and the diagnostic monitor 134 is preferably a UDM interface that is supplied with the diagnostic monitor software 134. The diagnostic monitor software 134 communicates with a MUT (Mobile Under Test) controller software entity 230 and a SM (Supporting Mobile) controller software entity 240 through an interface (preferably a PTT interface). The MUT controller software entity 230 is connected, in the embodiment of FIG. 5, via UTS software device driver 128 to a physical MUT 130. The connection is shown using reference “C” in FIG. 5.

The test executive software 138 is also connected with wireless channel emulator control software 244, which through the operating system is connected to a wireless channel emulator 144 which is shown using reference “B” in FIG. 5.

The PTT interface, represented by arrow PTT of FIG. 5, is also called the PTT component interface. The PTT interface is commercially available and packaged with a Spirent PoC Test System, manufactured by Spirent Communications of Rockville, Md., the assignee of the present invention. The corresponding MUT controller software entity 230 (also referred to as PTT1 in FIG. 5) performs various functions including, but not limited to the following: powering up and down the handsets, resetting handsets, “push”, specified time delays, push and hold, various verifications including active, dormant and contacts, wait for IP assignment, wait for origination, and wait for registration. One of ordinary skill in the art could determine and perform the various functions for interface.

The SM controller software entity 240 is connected to various emulation components represented in FIG. 5 within a dotted box labeled “Emulation Components”. The emulation components comprise an EVRC software utility 141, the emulated supporting mobile 140 and an emulated control server 146. Emulated components 140 and 240 representing the emulated supporting mobile and supporting mobile control software, respectively, are illustrated using expanded blocks representing the ability of the system to have more than one of each so that a variety of testing can be done including group and/or buddy emulation and testing.

The EVRC (enhanced variable rate vocoder) software utility 141 provides analog to digital voice data and compression and connects with the emulated mobile 140 via the UTS interface. The EVRC also connects with the SM controller software entity 240 via the UTS interface. The emulated mobile 140 is preferably a UTS device driver similar to device driver 128. The emulated control server 146 interfaces with the emulated mobile 140 via an IP (Internet Protocol) interface. The emulated control server 146 is a software entity residing, in the preferred embodiment, on a Win2003 Server. The location, on a separate server, of the emulated control server 146 is denoted by a dashed line that outlines the control server 146 in FIG. 5.

An IP connection is used between emulated control server 146 and network emulator control software 242. The network emulator control software 242 communicates via IP connection to a DNS (Domain Naming System) 156 and the emulated control server 146. The DNS resolves the operational web address to the IP address of the emulated control server 146 by translating a host name into an IP address. The dashed line outline notation is used to denote the separate server location of the DNS 156. The network emulator control software 242 connects to a CDMA network emulator 142 via the operating system, and to the test executive software 138 as shown using reference “A” in FIG. 5. The CDMA network emulator 142 is connected to wireless channel emulator 144. The CDMA network emulator 142 is also connected to physical MUT 130 and provides RF signal to physical MUT 130.

The MCI interface between the SM controller software entity and the emulated mobile 140 is a Windows MCI interface. The MCI interface provides an interface between MUT controller software entity 230 and an audio device driver 148. The audio device driver 148 is preferably a commercially available Lynxone audio device driver. The audio device driver 148 is used to record and playback audio signals. SM controller software entity 240 interfaces with emulated mobile 140 via both the MCI and UTS interfaces. The audio device driver 148 is connected via the operating system to audio card 105. The audio card 105, which is part of system controller PC 100′, connects to physical MUT 130.

The physical mobile's MUT controller software entity 230 and supporting mobile's 140 SM controller software entity 240 each access one or more audio files 160 (i.e., a .wav file) stored on the system controller PC 100′ via an FSI (file system interface) interface.

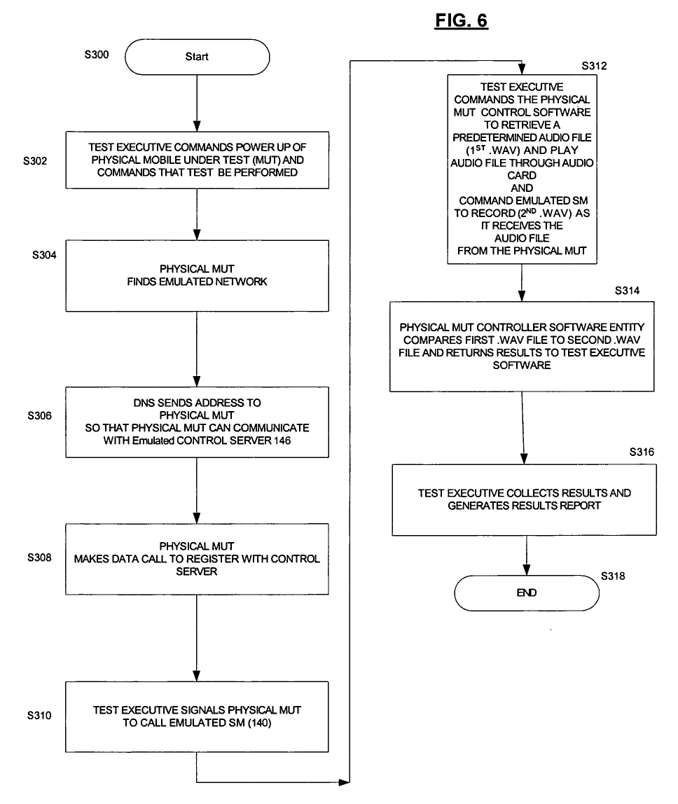

FIG. 6 shows a flowchart illustrating steps that are performed by the test system 200 of the embodiment of FIG. 5. At start S300, the method begins. At step S302, test executive 138 commands power up of the physical MUT 130 and commands that a test be performed. The test can be any of a variety of tests available through the use of the test executive 138 such as, for example, dormant-to-dormant timing, active-to-active timing or active-to-dormant timing. Next, at step S304, the physical MUT 130 finds the emulated network 142. At step S306 the DNS 156 sends an IP address to the physical MUT 130 so that physical MUT 130 can communicate with the emulated control server 146. Next, at step S308, the physical MUT 130 makes a data call to register with the emulated control server 146. At step S310, the test executive 138 signals the physical MUT to call the emulated SM 140.

The test executive 138 commands the physical MUT control software 230 to retrieve a predetermined audio file 160 from the system controller PC 100′ and play the audio file through the audio card while also commanding the emulated SM 140 to record as it receives the audio file from the physical MUT 130. The audio file can be for example a .wav file. For the purpose of the present example, the predetermined audio file, or .wav file, that was played by the physical MUT 130 is a first signal; and the audio recorded by the emulated SM 140 is a second signal. At step S314, the physical MUT controller software entity compares the first .wav file to the second (recorded) .wav file and returns comparison results to the test executive software 138. At step S316, the test executive 138 collects results and generates a results report (not shown). At terminator S318 the method example ends.

It should be noted that implicit in the method described is that the test executive 138 instructs the physical MUT 130 to perform various functions; it does so through the use of a control file. The test executive 138 instructs both the physical MUT 130 and the emulated SM 140 through the controller software entities 230, 240, respectively.

Other tests can be performed using the embodiment of FIG. 5 or other embodiments of the present system. For example, a test scenario reverse of the scenario of FIG. 6 could be performed where the emulated SM 140 could send the .wav file and the physical MUT 130 receive and record the signal. Hence the test would be performed in the opposite direction. Additionally, while in the example audio files were used, other types of files, such as for example, video could be tested.

FIGS. 5a-b show some possible configurations for the test system 200. Other configurations may be possible. It should be noted that some of the configurations shown might need additional hardware which could be determined by one of ordinary skill in the art. Each configuration is labeled with a suitable title for ease of reference; the titles are not intended for use in interpreting the configuration.

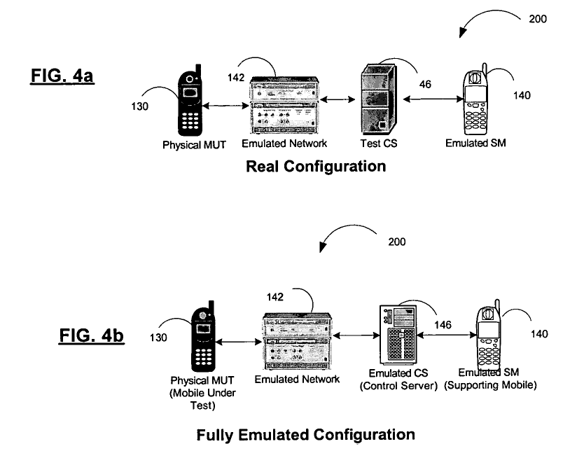

FIG. 4a shows a block diagram illustrating a configuration of a test system 200 integrating an embodiment of the present invention. The block diagram illustrates a test system 200 comprising physical MUT 130, an emulated network 142, a test control server 46 and emulated supporting mobile 140. The test control server 46 can be a Winphoria test control server commercially available from Winphoria Networks Inc. of Tewskbury, Mass. This “real configuration” provides interoperability testing between a real control server 46 and the emulated supporting mobile 140.

FIG. 4b shows another block diagram illustrating a configuration of a test system integrating an embodiment of the present invention. The block diagram illustrates a test system comprising physical MUT 130, an emulated network 142, an emulated control server 146 and emulated supporting mobile 140. The “fully emulated configuration” provides more control over testing (such as, for example, the ability to test the MUTs reaction to server failure conditions) than the system of FIG. 4a. No elements of a live network are used in the system 200 of FIG. 4b.

The present invention facilitates performance and protocol testing of PTT handsets using Emulated Supporting Mobiles (ESM). Testing of the PTT features requires interaction between the MUT and one or more supporting mobiles. Supporting mobiles are required to facilitate PTT Buddy and Group calls. Supporting mobiles can be either real mobiles or emulated mobiles. Software based emulated mobiles allow for a more flexible and scaleable PTT test solution. The software based emulated supporting mobiles are also more reliable and the tests performed with them are repeatable. Further, software based emulated supporting mobiles remove variability in RF, IP, Protocol, Device and PTT Clients that may be present when using real mobiles.

Although various embodiments which incorporate the teachings of the present invention have been shown and described in detail herein, those skilled in the art can readily devise many other varied embodiments that still incorporate these teachings.

I claim:

1. A test system for testing a communication device, the communication device configured for transmitting and receiving packet data, the test system residing on a system controller computer, the test system comprising:
an emulated communication device for transmitting and receiving packet data; and
a controller for controlling the emulated communications device, the controller operatively connected to the emulated communication device;
wherein the controller enables the emulated communications device to emulate the communications device by performing functions that the communication device performs.

2. The test system as claimed in claim 1 wherein the communication device is a push to talk over cellular (PoC) wireless telecommunications device.

3. The test system as claimed in claim 1 wherein the functions performed by the emulated communications device include transmission and receipt of packet data.

4. The test system as claimed in claim 2 wherein the controller for controlling the emulated communications device commands the emulated mobile to perform PoC functions.

5. The test system as claimed in claim 4 wherein the PoC functions include a push function.

6. The test system as claimed in claim 4 wherein the PoC functions include a push and hold function.

7. The test system as claimed in claim 4 wherein the PoC functions include a verification function.

8. The test system as claimed in claim 4 wherein the PoC functions include a time delays function.

9. The test system as claimed in claim 4 wherein the PoC functions include a wait for IP assignment function.

10. The test system as claimed in claim 4 wherein the PoC functions include a wait for registration function.

11. A method for testing a communication device, the communication device configured for transmitting and receiving packet data, the method comprising the steps of:
a) providing an emulated communications device configured for transmitting and receiving packet data;
b) obtaining a first data by the communications device;
c) sending a first data in packet data format from the communication device to the emulated communications device;
d) receiving by the emulated communication device the first data sent in packet data format by the communications device;
e) recording by the emulated communications device, the first data sent in packet data format by the communications device;
f) obtaining the first data by the emulated communications device; and
g) comparing the first data obtained by the emulated communications device with the recorded data recorded by the emulated communications device.

12. The method as claimed in claim 11 further comprising the step of:
h) determining whether the first data obtained by the emulated communications device is similar to the recorded data recorded by the emulated communications device.

13. The method as claimed in claim 12 further comprising the step of:
i) reporting the results of the comparing and determining steps to a user.

14. The method as claimed in claim 13 wherein the first data is stored on a system controller computer.

15. The method as claimed in claim 13 wherein the first data is audio data stored in a .wav format.
